(19) United States
(12) Patent Application Publication
(10) Pub. No.: US 2026/0307313 A1
(43) Pub. Date: Oct. 8, 2026

(54) INFORMATION PROCESSING DEVICE, INJECTION MOLDING SYSTEM, INJECTION MOLDING MACHINE, NON-TRANSITORY COMPUTER READABLE STORAGE MEDIUM STORING A PROGRAM, MACHINE LEARNING METHOD, AND INFERENCE MODEL

(71) Applicant: SUMITOMO HEAVY INDUSTRIES, LTD., Tokyo (JP)

(72) Inventors: Takuya MIZUNASHI, Chiba-shi (JP); Yuki MATSUI, Chiba-shi (JP); Daigo HOTTA, Chiba-shi (JP)

(21) Appl. No.: 19/548,536

(22) Filed: Feb. 24, 2026

(30) Foreign Application Priority Data
Apr. 8, 2025 (JP) 2025-063741

(51) Int. Cl. B29C 45/76

(52) U.S. Cl. CPC B29C 45/76; B29C 2945/761; B29C 2945/76254; B29C 2945/76949

(57) ABSTRACT

An information processing device includes acquisition circuitry that acquires three-dimensional shape data of a mold used for injection molding, and estimation circuitry that estimates a molding condition by using an inference model representing a relationship between input data including at least the three-dimensional shape data of the mold and the molding condition of an injection molding machine that uses the mold, and by using at least the three-dimensional shape data of the mold, which is acquired by the acquisition circuitry, as an input.

### CROSS-REFERENCE TO RELATED APPLICATIONS

This application claims priority to Japanese Patent Application No. 2025-063741, filed on Apr. 8, 2025, which is incorporated by reference herein in its entirety.

### BACKGROUND

### Technical Field

A certain embodiment of the present invention relates to an information processing device, an injection molding system, an injection molding machine, a non-transitory computer readable storage medium storing a program, a machine learning method, and an inference model.

### Description of Related Art

The injection molding machine produces a molding product by injection molding according to set molding conditions. There are various related arts for optimizing molding conditions of an injection molding machine. For example, there is a technique of inputting information on a mold used for producing a molding product and estimating molding conditions necessary for obtaining input molding quality by using machine learning.

The related art discloses an injection molding machine system including a computer and a plurality of injection molding machines. The computer is provided with a multilayer neural network, and a data set collected in each of the plurality of injection molding machines is input to the computer for learning. The data set includes specification data of the injection

molding machine, molding condition data, a plurality of pieces of molding product image data captured from various distances and angles, and a plurality of pieces of mold image data captured from various distances and angles. In the neural network, the specification data, the mold image data, and the molding product image data are input to and processed by neurons in an input layer, and the molding condition data is provided to and learned by neurons in an output layer as a training signal.

### SUMMARY

One or more embodiments provides an information processing device including acquisition circuitry that acquires three-dimensional shape data of a mold used for injection molding, and estimation circuitry that estimates a molding condition by using an inference model representing a relationship between input data including at least the three-dimensional shape data of the mold and the molding condition of an injection molding machine that uses the mold, and by using at least the three-dimensional shape data of the mold, which is acquired by the acquisition circuitry, as an input.

### BRIEF DESCRIPTION OF THE DRAWINGS

FIG. 1 is a view illustrating a configuration of an injection molding machine to which the present embodiment is applied.

FIG. 2 is a view illustrating a configuration of a control device.

FIG. 3 is a view illustrating a configuration of a data processing device.

FIG. 4 is a view illustrating a configuration of an information processing device.

FIG. 5 is a view illustrating a hardware configuration example of a computer that realizes the information processing device.

FIG. 6 is a view illustrating a relationship between an inference model, and input data and output data.

FIG. 7 is a view illustrating a two-stage inference model and a relationship between the input data and the output data.

FIG. 8 is a view illustrating a two-stage inference model in a case where actual result data is added to the input data, and a relationship between the input data and the output data.

FIG. 9 is a view illustrating a modification example of the present embodiment.

### DETAILED DESCRIPTION

In estimating the molding conditions of the injection molding machine by using machine learning, in a case where an image is used as input information to an inference model, there is a case where estimation accuracy is lowered because there is a portion that is difficult to represent in an image depending on a shape of an object.

According to the present invention, it is possible to improve the estimation accuracy in the estimation of the molding conditions of the injection molding machine using the inference model.

Hereinafter, embodiments of the present invention will be described in detail with reference to the accompanying drawings.

### Device Configuration

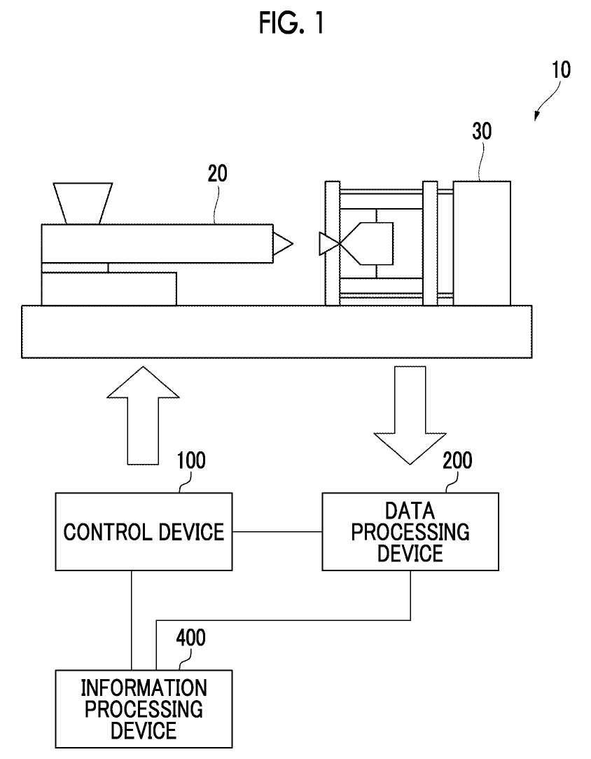

FIG. 1 is a view illustrating a configuration of an injection molding machine to which the present embodiment is applied. An injection molding machine 10 includes an injection unit 20, a mold clamping unit 30, a control device 100, and a data processing device 200. The injection molding machine 10 is an example of control target equipment. In addition, an information processing device 400 is connected to the control device 100 and the data processing device 200.

The injection unit 20 includes a cylinder that heats a molding material, a screw that is rotatable in the cylinder and that is provided to be able to advance and retreat in an axial direction, a rotary motor that drives the screw in a rotation direction, a motor that drives the screw in the axial direction, and the like. The molding material is, for example, a resin. The injection unit 20 injects the molding material heated and liquefied in the cylinder by advancing in a direction (forward) toward the mold clamping unit 30 from the injection unit 20 while rotating the screw, and fills a mold of the mold clamping unit 30 disposed in front of the injection unit 20 with the molding material. The injection unit 20 performs, for example, a plasticizing process, a filling process, a pressure holding process, or the like in a process of producing a molding product. The filling process and the pressure holding process may be collectively referred to as an injection process.

The mold clamping unit 30 includes a mold, a clamping mechanism that clamps the mold, and a motor that drives the clamping mechanism. The mold clamping unit 30 closes the mold to receive a molding material injected from the injection unit 20 into the mold. At this time, the mold clamping unit 30 clamps the mold by the clamping mechanism such that the mold is not opened by filling of the molding material (mold clamping). A molding product is formed by solidifying the molding material filled in the mold. After this, the mold clamping unit 30 opens the mold, and the molding product can be taken out. The mold clamping unit 30 performs, for example, a mold closing process, a pressure raising process, a mold clamping process, a depressurizing process, a mold opening process, or the like in a process of producing a molding product.

The control device 100 is a device that controls operations of the injection unit 20 and the mold clamping unit 30. The data processing device 200 is a device that processes data obtained as the injection unit 20 and the mold clamping unit 30 operate.

The information processing device 400 generates molding conditions used for the control of the injection unit 20 and the mold clamping unit 30 by the control device 100 based on various types of predetermined data, and transmits the molding conditions to the control device 100. The data used for generating the molding conditions by the information processing device 400 includes shape data (hereinafter, referred to as "three-dimensional shape data") representing a three-dimensional shape of the mold used in the injection molding. In addition, the data used for generating the molding conditions by the information processing device 400 may include, for example, various types of data such as waveform data and logging data obtained in correspondence with the operations of the injection unit 20 and the mold clamping unit 30. The waveform data is, for example, graph data based on time-series data representing various variables that change with the passage of time in the operations of the injection unit 20 and the mold clamping unit 30. Examples of an object represented by the waveform data include a voltage or a current supplied to each mechanism of the injection unit 20 and the mold clamping unit 30, a speed, an acceleration, or a pressure in the operation of each mechanism of the injection unit 20 and the mold clamping unit 30. Note that the waveform data may be a waveform obtained in association with actual operations of the injection unit 20 and the mold clamping unit 30, or may be a waveform obtained by performing an analysis such as a fluid analysis by an external analysis device. The logging data is data in which the molding conditions or actual result values are recorded in association with information for identifying a shot. As information for identifying the shot, for example, a shot number assigned to each shot or a time when the shot is performed can be used. Details of the information processed and output by the information processing device 400 will be described later.

### Configuration of Control Device 100

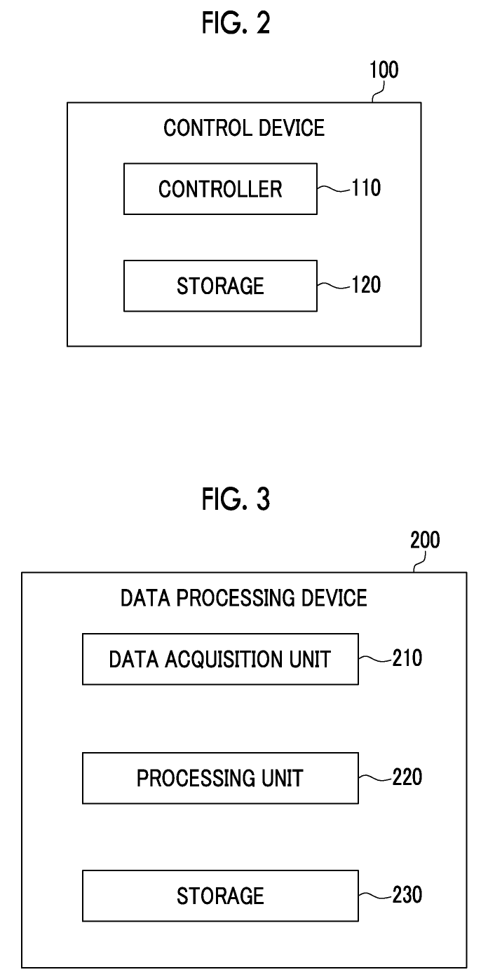

FIG. 2 is a view illustrating a configuration of the control device 100. The control device 100 controls the operations of the injection unit 20 and the mold clamping unit 30. The control device 100 is realized by, for example, a computer. The control device 100 includes a controller 110 and a storage 120. The control device 100 controls the injection unit 20 and the mold clamping unit 30 to repeatedly perform a process relating to production of the molding product, thereby repeatedly producing the molding product. The process relating to the production of the molding product includes a plasticizing process, a mold closing process, a pressure raising process, a mold clamping process, a filling process, a pressure holding process, a cooling process, a depressurizing process, a mold opening process, an ejection process, and the like. Hereinafter, these processes relating to the production may be collectively referred to as a “production process”. In addition, a series of operations for obtaining a molding product, for example, an operation from the start of the plasticizing process in the above production process to the start of the next plasticizing process is referred to as a “shot” or a “molding cycle”. Note that each of the above-described processes of producing the molding product is merely an example. For example, the process may include other processes not included in the above as a process executed in one shot.

The controller 110 controls the injection unit 20 and the mold clamping unit 30 based on control information. The control information is a condition set by a user, and is generated based on information input by the user by using, for example, an input unit (not illustrated). For example, the control information includes molding conditions such as a resin temperature, a mold temperature (a cylinder temperature), an injection pressure holding time, a metering value, a V-P switching position, a holding pressure, an injection speed (a filling speed), a screw rotation speed, a screw back pressure, and a mold clamping force. A plurality of combinations of these molding conditions are determined in correspondence with a molding product or a mold. Hereinafter, combination data of the molding conditions will be also referred to as a molding condition data set. In addition, the control information includes control data such as a voltage, a current, a pressure, a speed, and an acceleration for a driver such as a mechanism or a motor. The molding condition data set is prepared in correspondence with the type of the molding product, the mold, or the like and is stored in the storage 120.

The controller 110 controls the injection unit 20 and the mold clamping unit 30 by using the above-described molding condition data set, and performs a process relating to production (shot) of the molding product which includes the above-described processes. The controller 110 reads a molding condition data set corresponding to a molding product to be produced from the storage 120, for example, when the production of the molding product starts, or the like. Then, the controller 110 controls the operations of the injection unit 20 and the mold clamping unit 30 based on the control information including the read molding condition data set. Specifically, the controller 110 controls the injection unit 20 and the mold clamping unit 30 such that data obtained from the injection unit 20 and the mold clamping unit 30 in the production process matches a set value of the molding condition data set.

The storage 120 holds control information used for controlling the injection unit 20 and the mold clamping unit 30 by the controller 110. The molding condition data set included in the control information is prepared to be associated with a molding product to be produced or a mold. The storage 120 holds the molding condition data set for each molding product to be produced and for each mold. In addition, although not illustrated, the storage 120 holds a program for the controller 110 to control the injection unit 20 and the mold clamping unit 30. A function of the controller 110 is realized by a processor of the control device 100 by reading and executing the program held in the storage 120.

### Configuration of Data Processing Device 200

FIG. 3 is a view illustrating a configuration of the data processing device 200. The data processing device 200 acquires and processes data obtained as the injection unit 20 and the mold clamping unit 30 perform operations in the process relating to the production of the molding product. The data processing device 200 is realized by, for example, a computer.

The data processing device 200 includes a data acquisition unit 210, a processing unit 220, and a storage 230.

The data acquisition unit 210 acquires processing target data from the injection unit 20 and the mold clamping unit 30. Various sensors, detectors, and the like are attached to the injection unit 20 and the mold clamping unit 30. In addition, various measuring instruments may be connected to the injection unit 20 or the mold clamping unit 30. Data (hereinafter, referred to as "acquisition data") acquired by using these sensors, detectors, and measuring instruments is information representing a molding result obtained by the injection unit 20 and the mold clamping unit 30, and is used for quality control of a molding product. The data acquisition unit 210 receives the acquisition data transmitted from the sensors, the detectors, the measuring instruments, or the like, and stores the acquisition data in the storage 230.

The processing unit 220 processes the acquisition data stored in the storage 230. Specifically, the processing unit 220 performs processing such as extraction of a representative value of the acquisition data in each process, and generation of time-series data in which the acquisition data in each process is time-series. In the extraction of the representative value, the processing unit 220 performs statistical processing such as calculating of an average value, specifying a value acquisition range, and specifying a maximum value or a minimum value with respect to the acquisition data.

The storage 230 holds the acquisition data acquired by the data acquisition unit 210. As a data format of the acquisition data held in the storage 230, for example, binary, text, comma-separated values (CSV), INI, YAML Ain’t Markup Language (YAML), JavaScript Object Notation (JSON), or the like may be used. By using data files in these general-purpose data formats, it is possible to perform data exchange of the data files held in the storage 230 with other information processing devices or to edit the data files acquired from an external device. In addition, although not illustrated, the storage 230 holds a program for the processing unit 220 to execute data processing. In the data processing device 200, a processor reads and executes the program held in the storage 230, whereby a function of the processing unit 220 is realized.

### Configuration of Information Processing Device 400

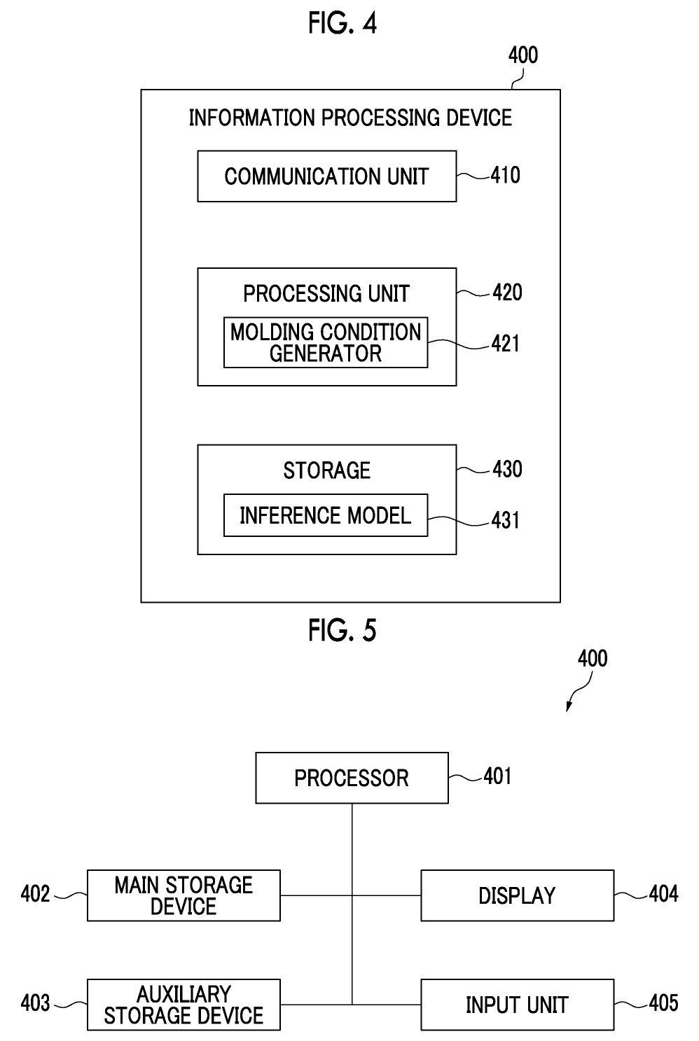

FIG. 4 is a view illustrating a configuration of the information processing device 400. The information processing device 400 inputs various types of data (hereinafter, “input data”) relating to injection molding to an inference model, and generates and outputs molding conditions in an operation of the injection molding machine 10. The information processing device 400 is realized by, for example, a computer. The information processing device 400 includes a communication unit 410, a processing unit 420, and a storage 430. The processing unit 420 includes a molding condition generator 421 that generates the molding conditions of the injection molding machine 10 by using the inference model. The storage 430 holds an inference model 431 used to generate the molding conditions by the molding condition generator 421.

The communication unit 410 receives actual result data by the operation of the injection molding machine 10 from the control device 100 and the data processing device 200. The actual result data is data obtained by the injection molding machine 10 performing a process of producing a molding product. The actual result data includes waveform data and logging data obtained in correspondence with the operation of the injection molding machine 10. In addition, the communication unit 410 transmits the molding conditions in the operation of the injection molding machine 10 to the control device 100. The molding conditions are generated by processing of the processing unit 420. The communication unit 410 is an example of acquisition means.

The processing unit 420 generates information used for controlling the injection unit 20 and the mold clamping unit 30 by the control device 100. The information used for controlling the injection unit 20 and the mold clamping unit 30 includes the molding conditions. The processing unit 420 inputs various types of input data to the molding condition generator 421. The input data includes at least three-dimensional shape data of a mold used for injection molding. The input data may include data (hereinafter, referred to as “resin data”) of a resin used in injection molding, specification data (hereinafter, referred to as “machine specification data”) of the injection molding machine 10, waveform data, logging data, or the like.

The molding condition generator 421 inputs the input data to the inference model 431 held in the storage 430, generates molding conditions corresponding to the input data, and outputs the molding conditions. For example, a deep learning model is used as the inference model 431. The molding condition generator 421 extracts a feature amount of the input data that is input by using the inference model 431, and estimates molding conditions corresponding to the input data based on the extracted feature amount. The molding condition generator 421 is an example of estimation means.

The storage 430 holds the actual result data received by the communication unit 410, the information obtained by processing of the processing unit 420, the inference model 431 used by the molding condition generator 421 of the processing unit 420, and the like. As a data format of a data file held in the storage 430, for example, a CSV, an Extensible Markup Language (XML), a JSON, or the like can be used.

### Hardware Configuration of Information Processing Device 400

FIG. 5 is a view illustrating a hardware configuration example of a computer that realizes the information processing device 400. The computer illustrated in FIG. 5 includes a processor 401 serving as calculation means, and a main storage device (main memory) 402 and an auxiliary storage device 403 serving as storage means. For example, as the processor 401, a central processing unit (CPU), a graphics processing unit (GPU), an application- specific integrated circuit (ASIC), a field-programmable gate array (FPGA), or various other calculation circuits can be used. The processor 401 reads a program stored in the auxiliary storage device 403 into the main storage device 402 and executes the program. For example, a random-access memory (RAM) is used as the main storage device 402. For example, a magnetic disk device, a solid-state drive (SSD), or the like is used as the auxiliary storage device 403.

In addition, the computer may include a display 404 for displaying an image and an input unit 405 as input means for an input operation performed by a user of the computer. For example, a keyboard, a mouse, a touch panel, or the like is used as the input unit 405. In a case where a touch panel configured integrally with the display 404 is used as the input unit 405, the user performs an input operation by touching an operation screen displayed on the display 404 with a finger or a pen-type device. Note that the configuration of the computer illustrated in FIG. 5 is merely an example, and the computer used in the present embodiment is not limited to the configuration example of FIG. 5. For example, a non-volatile memory such as a flash memory or a read-only memory (ROM) may be provided as the storage device.

In a case where the information processing device 400 is realized by the computer illustrated in FIG. 5, the communication unit 410 is realized by, for example, the processor 401 that reads and executes a program and a communication interface (not illustrated). A function of the processing unit 420 is realized, for example, by the processor 401 reading and executing the program. The storage 430 is realized by, for example, the auxiliary storage device 403.

### Inference of Molding Conditions by Inference Model 431

As described above, the molding condition generator 421 generates the molding conditions of the injection molding machine 10 by using the inference model 431. In addition, for example, a deep learning model is used as the inference model 431. Various types of data that affect the molding conditions can be selected as input data input to the inference model 431. Here, it is assumed that the input data includes at least three-dimensional shape data of a mold used for injection molding.

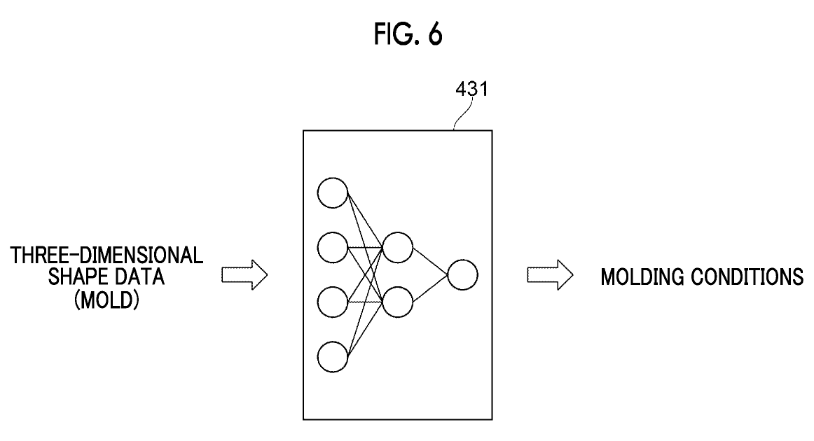

FIG. 6 is a view illustrating the inference model 431 and a relationship between input data and output data. In an example illustrated in FIG. 6, the three-dimensional shape data of the mold is used as the input data. The output data is the molding conditions. The inference model 431 is a model representing a relationship between a three-dimensional shape of the mold and the molding conditions. As illustrated in FIG. 6, when the three-dimensional shape data of the mold is input to the inference model 431 as input data, the inference model 431 infers molding conditions corresponding to the three-dimensional shape of the mold relating to the input data, and outputs the molding conditions as output data. The output molding conditions are sent to the control device 100 and are set as molding conditions for controlling the operations of the injection unit 20 and the mold clamping unit 30. Here, the output data may be the molding conditions as initial conditions set in the control device 100. In addition, the output data may be the amount of correction with respect to the current molding conditions set in the control device 100.

The shape of the mold corresponds to a shape of a molding product. Therefore, using the three-dimensional shape data of the mold as the input data is equivalent to using information on the shape of the molding product as the input data before the molding product is produced. There are several types of data formats that express a three-dimensional shape. Examples of the data formats that express the three-dimensional shape include three-dimensional point group data, a depth map, a voxel, a mesh, a surface, a solid, and the like.

The three-dimensional point group data is a data format in which a three-dimensional shape of an object is expressed by a collection of points. The three-dimensional point group data is aggregated data of three-dimensional vertex coordinates (x, y, z) corresponding to the shape of the object. The depth map is a data format in which a depth is added in addition to a color channel of an image. The voxel is a data format that expresses a three-dimensional shape of an object by using a cube as a minimum unit of volume in a three-dimensional space. The mesh is a data format that expresses a three-dimensional shape of an object by a collection of triangular surfaces and a direction (normal line) of each surface. The surface is a data format that mathematically expresses a surface (curved surface) of a three-dimensional shape. The solid is a data format that expresses a three-dimensional shape of a three-dimensional object having solid volume information.

The three-dimensional shape data of the mold used as the input data can use the various types of data formats described above in the molding condition generator 421. However, the three-dimensional point group data has advantages such as good data efficiency and easy measurement as compared with other data formats. Therefore, the three-dimensional point group data may be used as the three-dimensional shape data of the mold. Note that the data efficiency is an index indicating how much wide space can be expressed with respect to the amount of data. Measurement of the three-dimensional shape data can be performed by using, for example, existing techniques such as a laser scanner and photogrammetry.

Examples of the input data include data relating to a specification used for injection molding in addition to the above-described three-dimensional shape data of the mold. Examples of the data relating to the specification include data (hereinafter, referred to as "resin data") of a resin used in the injection molding and data (hereinafter, referred to as "machine specification data") of a machine specification of the injection molding machine 10. Examples of the resin data include data such as a viscosity and a melt flow rate (MFR). Examples of the machine specification data include data such as a screw diameter of the injection unit 20.

Here, to perform the inference by using the three-dimensional shape data as the input data, it is necessary to extract a numerical value relating to a feature of the three-dimensional shape as a feature amount from the three-dimensional shape data. Therefore, in a case where the molding conditions are generated from the three-dimensional shape data, first, a feature amount is extracted from the three-dimensional shape data, and molding conditions corresponding to the three-dimensional shape data are generated based on the extracted feature amount. On the other hand, since data relating to the above-described specification is information that specifies a numerical value or a material type, the content of the data is directly used as the feature amount in the data. Therefore, in a case where a molding condition is generated from the data relating to the above-described specification, the molding conditions are immediately generated from the input data.

In a case where both the three-dimensional shape data and the data relating to the specification are used as the input data for generating the molding conditions, a process of extracting the feature amount is required with respect to the three-dimensional shape data, and a process of extracting the feature amount is not required with respect to the data relating to the specification. Note that the process of extracting the feature amount from the three-dimensional shape data and the process of generating the molding conditions based on the feature amount can be performed by using a deep learning model. Therefore, it is conceivable to generate the molding condition by using a two-stage deep learning model as the inference model 431. Then, data is input so that pre-stage and post-stage deep learning models are used for the three-dimensional shape data, and data is input so that only the deep learning model in the post-stage is used for the data relating to the specification.

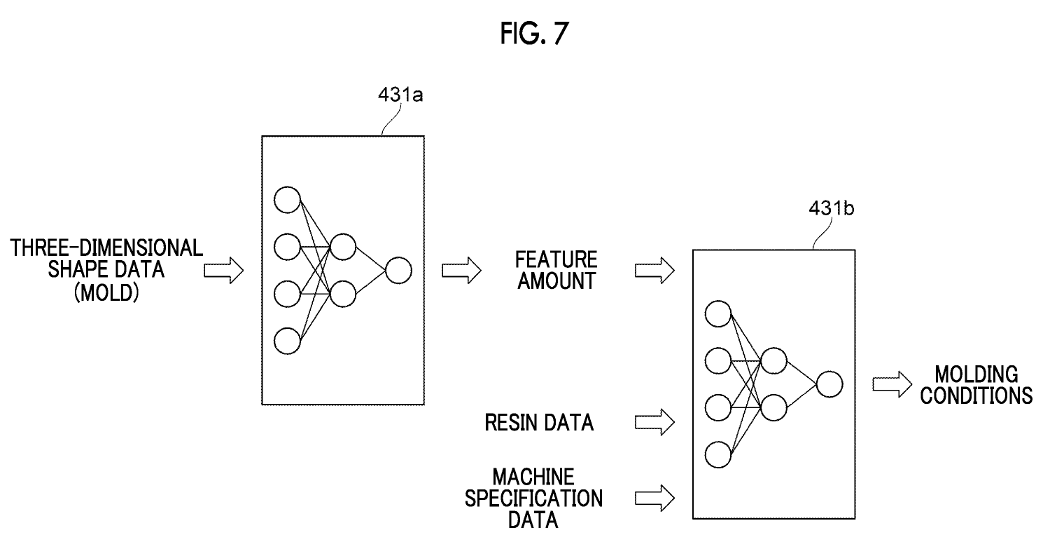

FIG. 7 is a view illustrating a relationship between two-stage inference models 431a and 431b, and the input data and the output data. In an example illustrated in FIG. 7, the inference model 431 includes the pre-stage inference model 431a and the post-stage inference model 431b. In the example illustrated in FIG. 7, the three-dimensional shape data of the mold, and the resin data and the machine specification data, which are the data relating to the specification, are used as the input data. Note that the inference model 431 illustrated in FIG. 6 can be identified as a combination of the inference models 431a and 431b illustrated in FIG. 7.

As illustrated in FIG. 7, three-dimensional shape data of the mold is input to the pre-stage inference model 431a. Then, the feature amount of the three-dimensional shape of the mold is extracted by the inference model 431a. The resin data and the machine specification data are input to the post-stage inference model 431b in combination with the feature amount of the three-dimensional shape of the mold output from the inference model 431a. Then, molding conditions corresponding to a combination of the input data is output by the inference model 431b. For this reason, in the example illustrated in FIG. 7, a process of extracting the feature amount by the pre-stage inference model 431a can be identified as a preprocess for the post-stage inference model 431b. In addition, in a case where the input data is input to the pre-stage inference model 431a, the input data passes through an intermediate layer of the inference model 431a and an intermediate layer of the inference model 431b. On the other hand, in a case where the input data is input to the post-stage inference model 431b, the input data passes through only the intermediate layer of the inference model 431b. In other words, in a case where the input data is input to the inference model 431a, the inference is performed through more intermediate layers as compared with a case where the input data is input to the inference model 431b. Therefore, input of the input data to the inference model 431a may be referred to as input to a deep layer, and input of the input data to the inference model 431b may be referred to as input to a shallow layer.

Note that here, the process of extracting the feature amount of the three-dimensional shape from the three-dimensional shape data and the process of estimating the molding conditions based on the feature amount of the three-dimensional shape and the data relating to the specification (the resin data and the machine specification data) have been separately described. However, this is merely an example of an internal calculation process. When two inference models in these processes are identified as one set, it can also be considered as one process of inputting the three-dimensional shape data of the mold and the data relating to the specification into one inference model and estimating the molding conditions.

In the example illustrated in FIG. 7, as the input data, an example is shown in which the molding conditions are generated by the inference model 431 (inference models 431a and 431b) by using the resin data and the machine specification data in addition to the three-dimensional shape data of the mold. In this example, it is possible to obtain the molding conditions corresponding to a more specific scenario as compared with a case where the molding conditions are generated based only on the three-dimensional shape data of the mold, and it is expected that accuracy of the molding conditions is improved. Here, furthermore, the actual result data obtained based on the operation of the actual injection molding machine 10 may be added to the input data.

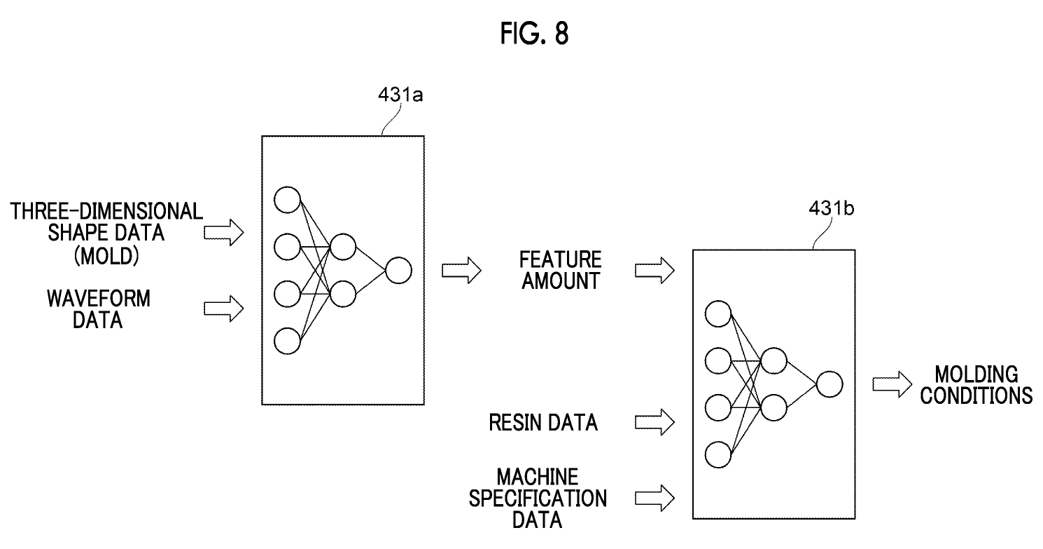

FIG. 8 is a view illustrating the two-stage inference models 431a and 431b in a case where the actual result data is added to the input data, and a relationship between the input data and the output data. In the example illustrated in FIG. 8, the inference model 431 is similar to the example illustrated in FIG. 7, and includes the pre-stage inference model 431a and the post-stage inference model 431b. In the example illustrated in FIG. 8, the three-dimensional shape data of the mold, the waveform data as the actual result data, and the resin data and the machine specification data as data relating to the specification are used as the input data.

The waveform data is graph data in which a variable that changes with the operation of the injection unit 20 and the mold clamping unit 30 is expressed in time-series. For this reason, to generate the molding conditions based on the waveform data, it is necessary to extract a feature amount of a waveform in the waveform data as in the case of the three-dimensional shape data. Therefore, the waveform data is input to the pre-stage inference model 431a (in a deep layer) in a similar manner as in the three-dimensional shape data of the mold.

In the example illustrated in FIG. 8, as the input data, the three-dimensional shape data of the mold, the resin data, and the machine specification data are used, and the waveform data as the actual result data is used to generate the molding conditions by the inference model 431 (inference models 431a and 431b). In this example, it is possible to obtain molding conditions corresponding to a more specific scenario including a specific situation obtained in an actual production process as compared with a case where the molding conditions are generated based on the three-dimensional shape data of the mold, the resin data, and the machine specification data. Therefore, even compared to the example illustrated in FIG. 7, further improvement in the accuracy of the molding conditions is expected. Further, in addition to the waveform data, the molding conditions may be generated by using the logging data as the actual result data. Since the logging data is obtained as a numerical value, the logging data is input to the inference model 431b in combination with, for example, the feature amount or the machine specification data. By adding the logging data to the input data, it is possible to obtain molding conditions corresponding to a more specific scenario, and it is expected that the accuracy of the molding conditions is further improved.

### Method of Training Inference Model 431

A method of training the inference model 431 will be described. First, a case where only the three-dimensional shape data of the mold is used as the input data will be described

with reference to FIG. 6. To train the inference model 431, a series of processes including a data acquisition process, a training process, and a storage process are performed. The data acquisition process is a process of acquiring a plurality of sets of training data including the input data and the output data. The training process is a process of training the inference model 431 with a correlation between the input data and the output data by machine learning by using the plurality of sets of training data acquired by the data acquisition process. The storage process is a process of storing the trained inference model 431 trained with the correlation by the training process in the storage 430. These processes are performed by, for example, the processing unit 420 of the information processing device 400.

In a case of training the inference model 431 with the relationship between the three-dimensional shape of the mold and the molding conditions, in the data acquisition process, a data set including the three-dimensional shape data of the mold, which is input data, and the data of the molding conditions, which is output data, is prepared as training data. The three-dimensional shape data of the mold is acquired from an actual mold by using, for example, existing techniques such as a laser scanner and photogrammetry. In addition, the three-dimensional shape data may be generated from design drawing information such as computer-aided design (CAD) data and drawing data and used as the input data. Furthermore, as the input data, in addition to the above-described data, estimated data of the molding conditions estimated by the inference model 431 may be used. With regard to the molding condition data, for example, the molding conditions are adjusted while actually performing the injection molding by using the mold, and molding conditions when a satisfactory result is obtained are acquired. In the training process, in prepared training data, the three-dimensional shape data of the mold is used as the input data, and the molding condition data is used as the output data, so that the inference model 431 is trained. In addition, estimated data of the molding conditions estimated for a mold of the same type as the mold relating to the three-dimensional shape data used for the input data may be used for the molding condition data as the output data in the data set. Then, in the storage process, the trained inference model 431 is stored in the storage 430 of the information processing device 400.

Even in a case where the inference model 431 includes the pre-stage inference model 431a and the post-stage inference model 431b as illustrated in FIGS. 7 and 8, the inference models 431a and 431b are similarly trained. However, the input data and the output data in the training data are different between the pre-stage inference model 431a and the post-stage inference model 431b. Therefore, individual training is performed for each of the inference models 431a and 431b.

### Embodiment

The present embodiment may be provided to a user as the information processing device 400 that holds the inference model 431 (including a case of being the inference models 431a and 431b) in the storage 430. In addition, the present embodiment may be provided to the user in a form of a program or the inference model 431 installed in the information processing device 400 possessed by the user. The program is installed in the information processing device 400 to realize the function of the molding condition generator 421 in the processing unit 420 of the information processing device 400. The inference model 431 is held in the storage 430 of the information processing device 400, and is used for generation of the molding conditions by the molding condition generator 421 of the processing unit 420. In these cases, various aspects can be considered as a training time of the inference model 431.

As an example, the trained inference model 431 or a program that has been trained in advance by using various specifications of the mold or the injection molding machine 10, or the information processing device 400 in which the inference model 431 is stored may be provided. In this case, the user can use the already trained inference model 431 to generate the molding conditions corresponding to the mold to be used and to set the controller 110 of the control device 100 of the injection molding machine 10.

In addition, as another example, the inference model 431 or a program that has not been trained, or the information processing device 400 in which the inference model 431 is stored may be provided, and the inference model 431 may be trained at a provision destination. In this case, a user trains the inference model 431 according to specifications of the mold and the injection molding machine 10 possessed by the user. Therefore, the user can make the inference model 431 be adapted to the mold and the injection molding machine 10 possessed by the user, and can improve the inference accuracy of the molding conditions.

In addition, as another example, the inference model 431 that has been trained in advance by using various specifications of the mold and the injection molding machine 10, the information processing device 400 in which the inference model 431 is stored, or the like may be provided, and the inference model 431 may be further trained at the provision destination. In other words, the trained inference model 431 is provided in an aspect in which adjustment is performed at the provision destination. In this case, the trained inference model 431 can be adapted to the mold and the injection molding machine 10 possessed by the user as compared with a case where the trained inference model 431 is used. On the other hand, as compared with a case where the inference model 431 is trained from the beginning at the provision destination, it is possible to reduce the effort required for training for adaptation to the mold or the injection molding machine 10 at the provision destination.

In the above-described aspect in which training is additionally performed at the provision destination of the inference model 431 after training of the inference model 431 is performed at a provider of the inference model 431, each of the data acquisition process, the training process, and the storage process is performed at each of the provider and the provision destination of the inference model 431. Here, a data acquisition process performed at the provider of the inference model 431 is referred to as a first acquisition process, and a data acquisition process performed at the provision destination of the inference model 431 is referred to as a second acquisition process. Similarly, a training process performed at the provider of the inference model 431 is referred to as a first training process, and a training process performed at the provision destination of the inference model 431 is referred to as a second training process. Note that the storage process is a process of storing the trained inference model 431 in the storage device, and thus the storage process is not particularly distinguished here.

In this case, in the first acquisition process, the three-dimensional shape data of the mold which can be prepared at the provider of the inference model 431, the data relating to the specifications (the resin data and the machine specification data), and the like are acquired as the input data. Then, training of the inference model 431 in the first training process is performed by using the input data.

On the other hand, in the second acquisition process, the waveform data or the logging data which is actually obtained by operating the injection molding machine 10 is acquired as the actual result data serving as the input data. In addition, the three-dimensional shape data of the mold actually used in production of a molding product by the injection molding machine 10 may be acquired as the input data. Then, the inference model 431 is trained in the second training process by using the input data.

### Modification Example

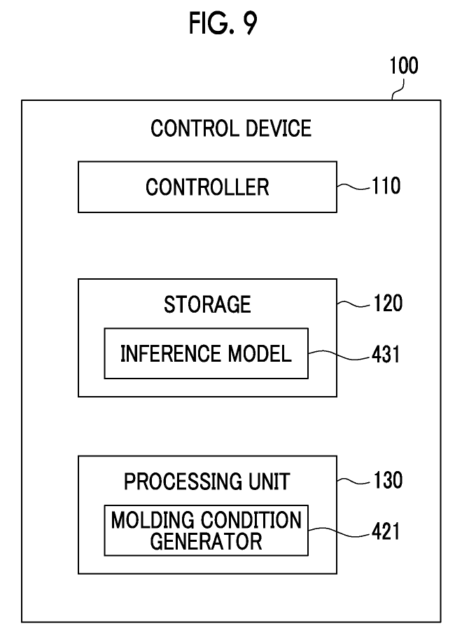

FIG. 9 is a view illustrating a modification example of the present embodiment. FIG. 9 illustrates a configuration of the control device 100 of the injection molding machine 10. The control device 100 illustrated in FIG. 9 includes a controller 110, a storage 120, and a processing unit 130. The processing unit 130 includes a molding condition generator 421.

The inference model 431 is held in the storage 120. That is, in the modification example illustrated in FIG. 9, the function of the molding condition generator 421 provided in the processing unit 420 of the information processing device 400 described with reference to FIG. 4 is realized by the processing unit 130 of the control device 100. The molding condition generator 421 of the processing unit 130 generates molding conditions for the controller 110 to control the operations of the injection unit 20 and the mold clamping unit 30 by using the inference model 431 held in the storage 120.

The functions of the molding condition generator 421 and the inference model 431 held in the storage 120 of the processing unit 130 are similar to those of the molding condition generator 421 and the inference model 431 provided in the information processing device 400. In a case of this modification example, the present embodiment is provided, for example, as a program for realizing the function of the molding condition generator 421 in the processor of the control device 100 and as the inference model 431. Note that in this modification example, the input data used for generating the molding conditions is input, for example, via a communication interface (not illustrated) used for data exchange with an external device in the control device 100.

Although the embodiment of the present invention has been described above, the technical scope of the present invention is not limited to the above-described embodiment. Various changes and modifications of the configuration without departing from the scope of the technical idea of the present invention are included in the present invention.

It should be understood that the invention is not limited to the above-described embodiment, but may be modified into various forms on the basis of the spirit of the invention. Additionally, the modifications are included in the scope of the invention.

What is claimed is:

1. An information processing device comprising:
acquisition circuitry that acquires three-dimensional shape data of a mold used for injection molding; and
estimation circuitry that estimates a molding condition by using an inference model representing a relationship between input data including at least the three-dimensional shape data of the mold and the molding condition of an injection molding machine that uses the mold, and by using at least the three-dimensional shape data of the mold, which is acquired by the acquisition circuitry, as an input.

2. The information processing device according to claim 1, further comprising:
a storage that holds the inference model used for generation of the molding condition by the estimation circuitry.

3. The information processing device according to claim 2,
wherein the estimation circuitry inputs the input data to the inference model, extracts a feature amount of the input data, and estimates a molding condition corresponding to the input data based on the extracted feature amount.

4. The information processing device according to claim 1,
wherein the input data further includes data relating to a specification used for the injection molding by the injection molding machine.

5. The information processing device according to claim 4,
wherein the data relating to the specification includes at least data of a resin used for the injection molding by the injection molding machine or data of a machine specification in the injection molding machine.

6. The information processing device according to claim 5,
wherein the data of the resin includes data of a viscosity and a melt flow rate, and the data of the machine specification in the injection molding machine includes data of a screw diameter of an injection unit.

7. The information processing device according to claim 1,
wherein the input data further includes actual result data obtained by the injection molding machine by performing a process of producing a molding product.

8. The information processing device according to claim 7,
wherein the actual result data is waveform data indicating a variable that changes with a passage of time in an operation of the injection molding machine in time-series, or logging data obtained in correspondence with the operation of the injection molding machine.

9. The information processing device according to claim 1,
wherein the three-dimensional shape data of the mold, which is acquired by the acquisition circuitry, is three-dimensional point group data that expresses a three-dimensional shape of an object by a collection of points.

10. The information processing device according to claim 1,
wherein the estimation circuitry is configured to
extract a feature amount of a three-dimensional shape of the mold from the three-dimensional shape data of the mold by using a first inference model, and
estimate the molding condition corresponding to the mold based on the feature amount of the mold, which is obtained by using the first inference model, by using a second inference model.

11. The information processing device according to claim 10,
wherein the input data further includes data relating to a specification used for the injection molding by the injection molding machine, and
the estimation circuitry estimates the molding condition corresponding to the mold and the specification based on the feature amount of the three-dimensional shape of the mold and the data relating to the specification by using the second inference model.

12. The information processing device according to claim 10,
wherein the input data further includes actual result data obtained by the injection molding machine by performing a process of producing a molding product,
the actual result data is waveform data indicating a variable that changes with a passage of time in an operation of the injection molding machine in time-series, and
the estimation circuitry is configured to
extract the feature amount of the three-dimensional shape of the mold from the three-dimensional shape data of the mold and extract a feature amount of a waveform indicated by the waveform data from the waveform data, by using the first inference model, and
estimate the molding condition corresponding to the mold and the waveform data based on the feature amount of the three-dimensional shape of the mold and the feature amount of the waveform by using the second inference model.

13. An injection molding system comprising:
an injection molding machine that performs injection molding by using a mold;
a control device that controls an operation of the injection molding machine; and
the information processing device according to claim 1,
wherein the control device controls the operation of the injection molding machine based on a molding condition generated by the information processing device.

14. An injection molding machine comprising: an injection unit;
a mold clamping unit; and
a control device that controls an operation of injection molding performed by the injection unit and the mold clamping unit,
wherein the control device includes estimation circuitry that estimates a molding condition applied to the operation of the injection molding performed by the injection unit and the mold clamping unit by using an inference model representing a relationship between input data including at least three-dimensional shape data of a mold and the molding condition of the injection molding machine that uses the mold, and by using at least the three-dimensional shape data of the mold used in the operation of the injection molding performed by the injection unit and the mold clamping unit as an input.

15. A non-transitory computer readable storage medium storing a program that causes a computer to function as:
the acquisition circuitry and the estimation circuitry of the information processing device according to claim 1.

16. A machine learning method executed by a computer, the method comprising:
a data acquisition process of acquiring a plurality of sets of training data including input data and output data;
a training process of training a learning model with a correlation between the input data and the output data by machine learning using the plurality of sets of training data acquired by the data acquisition process; and
a storage process of storing the trained model, which has been trained with the correlation by the training process, in a storage device,
wherein the input data includes at least three-dimensional shape data of a mold used for injection molding, and
the output data includes a molding condition applied to an injection molding machine in a case where the injection molding is performed by using the mold.

17. The machine learning method according to claim 16,
wherein the data acquisition process includes
a first acquisition process of acquiring the input data including the three-dimensional shape data of the mold which can be acquired in advance without operating the injection molding machine, and
a second acquisition process of acquiring input data based on an actual operation result of the injection molding machine which is acquired by operating the injection molding machine, and
the training process includes
a first training process of training the learning model by using the input data acquired by the first acquisition process, and
a second training process of further training the learning model trained by the first training process by using the input data acquired by the second acquisition process.

18. The machine learning method according to claim 17,
wherein the input data acquired in the second acquisition process includes waveform data indicating a variable that changes with a passage of time in the operation of the injection molding machine in time-series, or logging data obtained in correspondence with the operation of the injection molding machine.

19. The machine learning method according to claim 17,
wherein the data acquired in the second acquisition process includes the three-dimensional shape data of the mold used for production of a molding product by the injection molding machine.

20. An inference model that causes a computer to:
input at least three-dimensional shape data of a mold used for injection molding, and output a molding condition applied to an injection molding machine in a case where the injection molding is performed by using the mold,
wherein the inference model is trained by the machine learning method according to claim 16.
